(19) United States
(12) Patent Application Publication
(10) Pub. No.: US 2023/0422351 A1
(43) Pub. Date: Dec. 28, 2023

(54) ELECTRONIC VAPORIZATION DEVICE AND HOLDER ASSEMBLY

(71) Applicant: Shenzhen Verdewell Technology Limited, Shenzhen (CN)

(72) Inventor: Jianguang ZHOU, Shenzhen (CN)

(21) Appl. No.: 18/341,284

(22) Filed: Jun. 26, 2023

(30) Foreign Application Priority Data
Jun. 27, 2022 (CN) 202221624595.4

(51) Int. Cl. H05B 3/06; A24F 40/46; H01R 12/51

(52) U.S. Cl. CPC H05B 3/06; A24F 40/46; H01R 12/51; H05B 2203/016

(57) ABSTRACT

A holder assembly includes: a holder; an electrical conductive member; a connection structure; and a positioning structure. The positioning structure and the connection structure are arranged on the holder and the electrical conductive member. The electrical conductive member is mounted and positioned on the holder through the positioning structure, is connected and fixed to the holder through the connection structure, and is in conductive connection to, through contact, a circuit board mounted into the holder.

### CROSS-REFERENCE TO PRIOR APPLICATION

Priority is claimed to Chinese Patent Application No. 202221624595.4, filed on Jun. 27, 2022, the entire disclosure of which is hereby incorporated by reference herein.

### FIELD

The utility model relates to the field of vaporization, and more specifically, to an electronic vaporization device and a holder assembly.

### BACKGROUND

On a holder of an electronic vaporization device in the related art, the electrical conductive member is usually a lead, and the lead is welded on a circuit board. However, welding of traditional assembly lines requires a plurality of skilled welding workers, which causes high labor costs and low efficiency. Moreover, the defect rate of manual welding lines is high, welding defects such as faulty welding and false welding exist, desoldering may be caused during production line transfer, line arranging, and transportation, the one-time pass rate is not high, and the quality is unstable, which is easy to cause problems such as customer complaints.

### SUMMARY

In an embodiment, the present invention provides a holder assembly, comprising: a holder; an electrical conductive member; a connection structure; and a positioning structure, wherein the positioning structure and the connection structure are arranged on the holder and the electrical conductive member, and wherein the electrical conductive member is mounted and positioned on the holder through the positioning structure, is connected and fixed to the holder through the connection structure, and is in conductive connection to, through contact, a circuit board mounted into the holder.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic vaporization device according to some embodiments of the utility model;

FIG. 2 is a schematic structural exploded view of the electronic vaporization device shown in FIG. 1;

FIG. 3 is a cross-sectional view of a power supply assembly of the electronic vaporization device shown in FIG. 2;

FIG. 4 is a schematic partial structural diagram of the power supply assembly of the electronic vaporization device shown in FIG. 3;

FIG. 5 is a schematic structural diagram of a holder assembly of the power supply assembly shown in FIG. 4;

FIG. 6 is a schematic structural diagram of a holder of the holder assembly shown in FIG. 5;

FIG. 7 is a schematic structural diagram of an electrical conductive member of the holder assembly shown in FIG. 5;

FIG. 8 is a schematic structural diagram of a first circuit board of the power supply assembly shown in FIG. 4; and

FIG. 9 is a schematic structural diagram of a second circuit board of the power supply assembly shown in FIG. 4.

### DETAILED DESCRIPTION

In an embodiment, the present invention provides an improved holder assembly and further provide an improved electronic vaporization device.

In an embodiment, the present invention provides a holder assembly, including a holder, an electrical conductive member, a connection structure, and a positioning structure, where the positioning structure and the connection structure are arranged on the holder and the electrical conductive member, and the electrical conductive member is mounted and positioned on the holder through the positioning structure, is connected and fixed to the holder through the connection structure, and is in conductive connection to, through contact, a circuit board mounted into the holder.

In some embodiments, the positioning structure includes a positioning hole and a positioning column, where the positioning column is arranged on the holder, and the positioning hole is provided on the electrical conductive member, is provided corresponding to the positioning column, and is configured for the positioning column to run through.

In some embodiments, the electrical conductive member includes a positioning portion; and the positioning hole is provided on the positioning portion.

In some embodiments, the connection structure includes a first connection hole, a second connection hole, and a fastener, where
the first connection hole is provided on the electrical conductive member, and the second connection hole is provided on the holder; and
the fastener runs through the first connection hole to the second connection hole, to connect the electrical conductive member to the holder.

In some embodiments, the electrical conductive member includes a conductive contact portion in contact with the circuit board; the first connection hole is provided on the conductive contact portion; and
the fastener runs through the circuit board and the first connection hole in sequence to be connected to the second connection hole, to connect the circuit board and the conductive contact portion to the holder.

In some embodiments, the conductive contact portion includes an annular conductive contact surface. In some embodiments, the electrical conductive member includes a connection portion arranged lengthwise; and
there are two conductive contact portions, and the two conductive contact portions are respectively arranged at both ends of the connection portion.

In some embodiments, a bending portion fitting with the holder is arranged between one or two of the conductive contact portions and the connection portion.

In some embodiments, the holder includes a first accommodating cavity accommodating a first circuit board and a second accommodating cavity arranged side by side with the first accommodating cavity and configured to accommodate a second circuit board; and
the electrical conductive member extends from the first accommodating cavity to the second accommodating cavity, and is in conductive connection to the first circuit board and the second circuit board respectively.

In some embodiments, there are two electrical conductive members, and the two electrical conductive members are spaced apart on the holder.

In some embodiments, a limiting groove is provided on the holder, and configured for mounting and limiting of the electrical conductive member. In some embodiments, the electrical conductive member is in a shape of a sheet.

In some embodiments, the electrical conductive member is an elastic member.

In some embodiments, the electrical conductive member includes a conductive contact portion; and a conductive layer is arranged on the conductive contact portion.

In the utility model, an electronic vaporization device is further constructed, including the holder assembly in the utility model and the circuit board mounted on the holder assembly, where the circuit board is connected to the electrical conductive member of the holder assembly through the connection structure on the holder assembly.

In some embodiments, a conductive portion in conductive contact with the electrical conductive member is arranged on the circuit board.

In some embodiments, an assembly hole for assembly of the connection structure is provided on the circuit board; and the conductive portion is arranged on a periphery of the assembly hole.

In some embodiments, the circuit board includes the first circuit board and the second circuit board; and the first circuit board and the second circuit board are spaced apart and are connected through the electrical conductive member.

Implementation of the electronic vaporization device and the holder assembly in the utility model has the following beneficial effects: In the holder assembly, the electrical conductive member can be mounted and positioned on the holder through the positioning structure, be connected and fixed to the holder through the connection structure, and be in conductive connection to, through contact, the circuit board mounted into the holder, so as to omit welding steps, reduce labor costs, and simplify the assembly process, thereby facilitating automatic assembly, and ensuring the quality of the electronic vaporization device.

To have a clearer understanding of the technical features, the objectives, and the effects of the utility model, specific implementations of the utility model are now illustrated in detail with reference to the accompanying drawings.

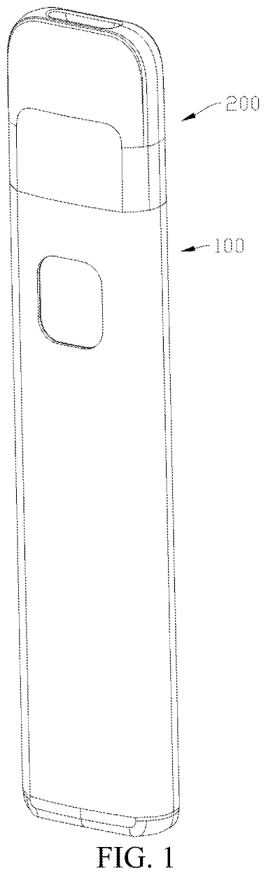

FIG. 1 show some exemplary embodiments of an electronic vaporization device of the utility model. In this embodiment, the electronic vaporization device includes a vaporizer 200 and a power supply assembly 100. The vaporizer 200 may be configured to heat a vaporizable medium, for example, e-liquid. The power supply assembly 100 may be mechanically and/or electrically connected to the vaporizer 200, and may supply power to vaporizer 200.

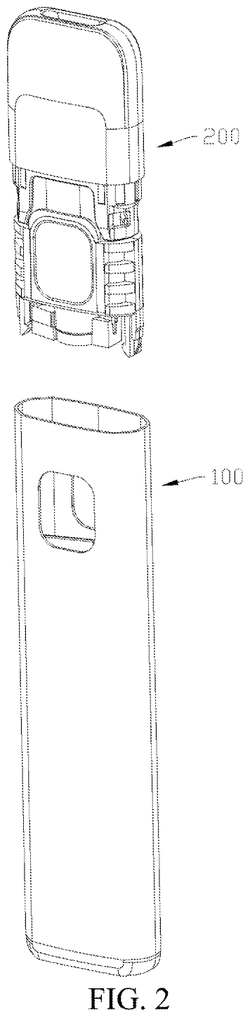

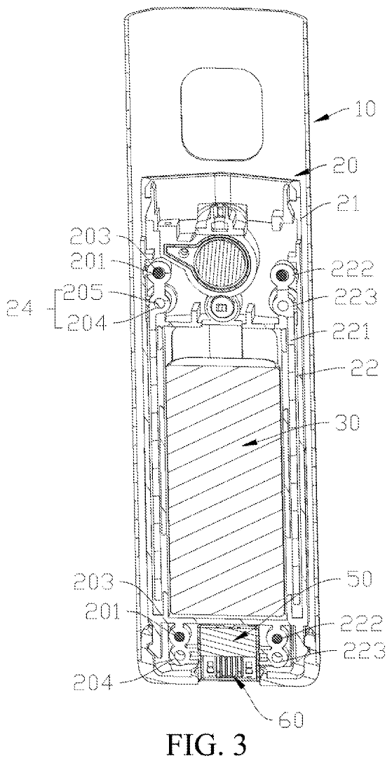

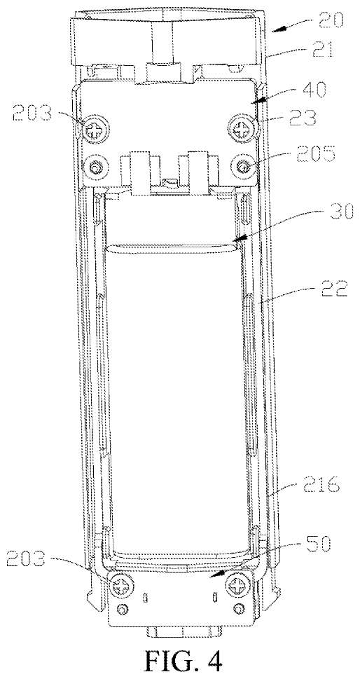

As shown in FIG. 2 to FIG. 4, further, in this embodiment, the power supply assembly 100 includes a shell 10, a holder assembly 20, a battery core 30, and a circuit board. The shell 10 is configured to accommodate the holder assembly 20, the battery core 30, and the circuit board 40. The holder assembly 20 is arranged in the shell 10, and can support the battery core 30 and the circuit board. The battery core 30 is arranged on the holder assembly 20 and located at the lower part of the holder assembly 20, and can supply power to the vaporizer. The circuit board may be arranged on the holder assembly 20 and in conductive connection to the battery core 30. In some embodiments, the circuit board may include a first circuit board 40 and a second circuit board 50. The first circuit board 40 may be in conductive connection to the battery core 30. The first circuit board 40 may be a main control board, and may be electrically connected to the vaporizer 200. The second circuit board 50 may be in conductive connection to the first circuit board 40, and the second circuit board 50 may be a charging circuit board.

Further, in some embodiments, the shell 10 has a cylindrical structure with an opening at one end. The shell 10 may be a plastic injection member. Certainly, it may be understood that, in some other embodiments, the shell 10 may alternatively be a metal shell.

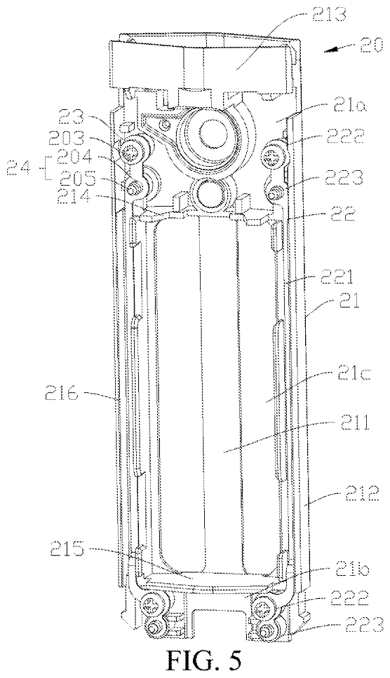

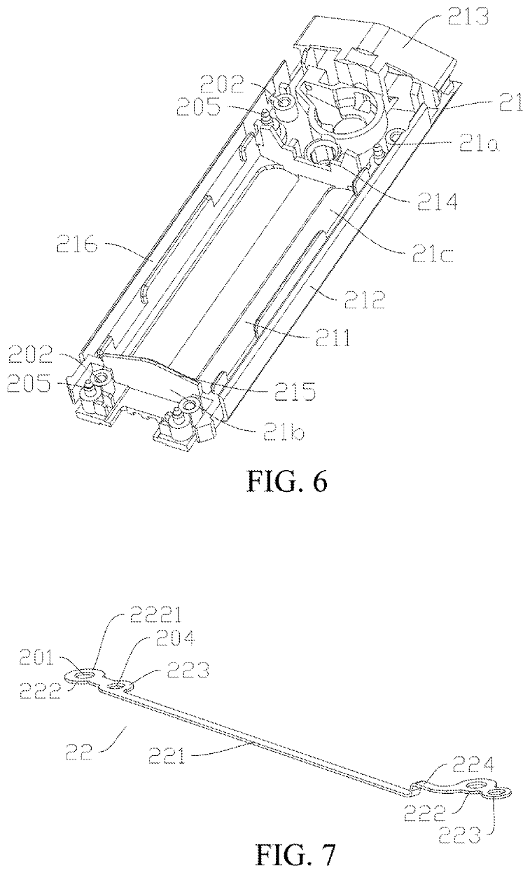

As shown in FIG. 5 and FIG. 6, further, in some embodiments, the holder assembly 20 includes a holder 21 and an electrical conductive member 22; and the holder 21 may be configured to support and accommodate the circuit board and the battery core 30. The electrical conductive member 22 is arranged on the holder 21, and configured to conductively connect the circuit board to the battery core 30.

Further, in some embodiments, the holder 21 may be a plastic injection member. Specifically, the holder 21 may be made of a plastic material. Certainly, it may be understood that, in some other embodiments, the holder 21 may not be limited to being made of a plastic material, and may alternatively be made of a ceramic material or other insulating materials. The holder 21 includes a bottom wall 211, side walls 212, an end wall 213, a first resisting wall 214, and a second resisting wall 215. The bottom wall 211 may be a long bottom wall, and the side walls 212 may be arranged on two opposite sides of the bottom wall 211. The side walls 212 may be short side walls and may be integrally formed with the bottom wall 211. The end wall 213 may be arranged at one end of the bottom wall 211. The first resisting wall 214 and the second resisting wall 215 may be spaced apart on the bottom wall 211 for dividing the inner space of the holder 21 into a first accommodating cavity 21a, a second accommodating cavity 21b, and a third accommodating cavity 21c. The first accommodating cavity 21a, the third accommodating cavity 21c, and the second accommodating cavity 21b are arranged side by side in sequence. The first accommodating cavity 21a is configured to accommodate the first circuit board 40. The second accommodating cavity 21b is configured to accommodate the second circuit board 50. The third accommodating cavity 21c is arranged between the first accommodating cavity 21a and the second accommodating cavity 21b, and configured to accommodate the battery core 30. In some embodiments, limiting grooves 216 are provided on the holder 21, and there are two limiting grooves 216. The two limiting grooves 216 are provided on two opposite sides of the third accommodating cavity 21c, and are configured for mounting and limiting of the electrical conductive member 22, to prevent the electrical conductive member 22 from moving on the holder 21 along the width direction of the third accommodating cavity 21c.

As shown in FIG. 7, further, in some embodiments, there may be two electrical conductive members 22, and the two electrical conductive members 22 may be spaced apart on the holder 21. Specifically, the two electrical conductive members may be arranged in one-to-one correspondence with the limiting grooves 216. The two electrical conductive members 22 have same structures and are respectively configured to form a positive path and a negative path. By setting the structures of the two electrical conductive members 22 to be the same, the manufacturing costs can be reduced, and during assembly of the electrical conductive members 22, there is no need to perform distinguishing, thereby simplifying the assembly process.

Further, in some embodiments, the electrical conductive member 22 may be in a shape of an elongated sheet, and may be an elastic member. Specifically, in some embodiments, the electrical conductive member 22 may be a metal elastic sheet. Optionally, in some embodiments, the electrical conductive member 22 may be made of a stainless steel material or a phosphor bronze material. Certainly, it may be understood that, in some other embodiments, the electrical conductive member 22 may not be limited to being made of a stainless steel material or a phosphor bronze material. In some embodiments, the electrical conductive member 22 may extend from the first accommodating cavity 21a through the third accommodating cavity 21c to the second accommodating cavity 21b, so as to conductively connect the first circuit board 40 to the second circuit board 50.

In some embodiments, the electrical conductive member 22 includes a connection portion 221, conductive contact portions 222, and positioning portions 223. The connection portion 221 is in a shape of an elongated sheet, and the length thereof may be greater than that of the third accommodating cavity 21c. There are two conductive contact portions 222, and the two conductive contact portions 222 may be arranged at both ends of the connection portion 221. The conductive contact portion 222 may be annular, and has an annular conductive contact surface 2221. The conductive contact surface 2221 may be in contact with the circuit board to realize electrical connection. In some embodiments, a conductive layer may be arranged on the conductive contact portion 222. Specifically, gold plating may be performed on the conductive contact portion 222 in an electroplating manner. Certainly, it may be understood that other manners may alternatively be used to form the conductive layer on the conductive contact portion 222. Certainly, in some embodiments, the material of the conductive layer is not limited to gold. The two conductive contact portions 222 may be in the first accommodating cavity 21a and the second accommodating cavity 21b respectively, and be connected to the first circuit board 40 and the second circuit board 50 respectively. There may be two positioning portions 223. The two positioning portions 223 are arranged at both ends of the connection portion 221, and may be arranged in the first accommodating cavity 21a and the second accommodating cavity 21b respectively. Specifically, the positioning portion 223 in the first accommodating cavity 21a may be arranged between the conductive contact portion 222 and the connection portion 221, and the positioning portion 223 in the second accommodating cavity 21b may be arranged on a side of the conductive contact portion 222 away from the connection portion 221. The positioning portion 223 may be configured for fitting and positioning with the holder 21, thereby improving the stability and accuracy of assembly of the electrical conductive member 22 and the holder 21. The connection portion 221, the conductive contact portions 222, and the positioning portion 223 may be integrally formed. In some embodiments, these members may be formed on a pre-formed member through bending and stamping.

In some embodiments, the height of the second resisting wall 215 between the second accommodating cavity 21b and the third accommodating cavity 21c is larger than the depth of the third accommodating cavity 21bc, and a bending portion 224 may be arranged between the conductive contact portion 222 extending toward the second accommodating cavity 21b and the connection portion 221. The bending portion 224 may fit with the holder 21. Specifically, the bending portion may fit with the second resisting wall 215, so that the conductive contact portion 222 bypasses the second resisting wall 215 and extends into the second accommodating cavity 21b. It may be understood that, in some embodiments, the bending portion 224 may be arranged between each of the two conductive contact portions 222 and the connection portion 221. Certainly, it may be understood that in some other embodiments, the bending portion 224 may alternatively be omitted.

In some embodiments, the holder assembly 20 further includes a connection structure 23. The connection structure 23 may be configured to connect the holder 21 to the electrical conductive member 22, and may be configured to connect and fix the electrical conductive member 22 to the holder 21. In some embodiments, there may be two connection structures 23, which are arranged corresponding to the two conductive contact portions 222. The connection structure 23 includes a first connection hole 201, a second connection hole 202, and a fastener 203. The first connection hole 201 is provided on the electrical conductive member 22. Specifically, in some embodiments, the first connection hole 201 is provided on the conductive contact portion 222 and runs through the thickness direction of the conductive contact portion 222. The second connection hole 202 is provided on the holder 21. Specifically, a connection column is arranged on each of the first accommodating cavity 21a and the second accommodating cavity 21b, and the second connection hole 202 is formed in the connection column. In some embodiments, the second connection hole 202 may be a threaded hole. The fastener 203 may be a screw. The fastener 203 may run through the first connection hole 201 to the second connection hole 202, and be screwed to the second connection hole 202, to connect the electrical conductive member 22 to the holder 21. By tightening the fastener 203, the conductive contact surface 2221 on the conductive contact portion 222 can be in contact with the first circuit board 40 and the second circuit board 50 to realize electrical connection.

In some embodiments, the holder assembly 20 further includes positioning structures 24, and there are two positioning structures 24. The two positioning structures 24 may be arranged in one-to-one correspondence with the positioning portions 223. By setting the positioning structure 24 to be capable of mounting and positioning the electrical conductive member 22 and the holder 21, the accuracy and efficiency of assembly can be further improved. In some embodiments, the positioning structure 24 includes a positioning hole 204 and a positioning column 205. The positioning hole 204 may be provided on the electrical conductive member 22. Specifically, in some embodiments, the positioning hole 204 may be provided on the positioning portion 223. Certainly, it may be understood that, in some other embodiments, the positioning hole 204 may not be limited to being provided on the positioning portion 223. The positioning column 205 is arranged on the holder 21. Specifically, the positioning column may be arranged in the first accommodating cavity 21a and the second accommodating cavity 21b, and arranged on the bottom wall 211 in a protruding manner. The positioning column 205 may be arranged in one-to-one correspondence with the positioning hole 204. When the electrical conductive member 22 is assembled with the holder 21, the positioning column 205 may pass through the positioning hole 204, to position and mount the electrical conductive member 22 with the holder 21.

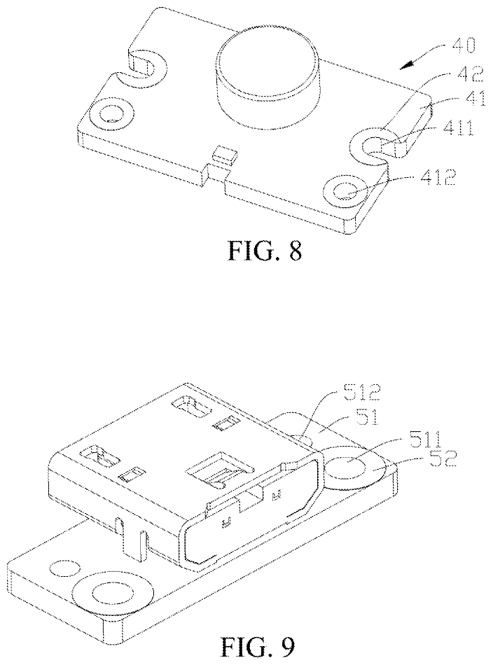

As shown in FIG. 8, in some embodiments, the first circuit board 40 may include a first board body 41 and a first conductive portion 42. The first board body 41 may be approximately square, and a control circuit connected to the vaporizer 200 and the battery core 30 is arranged on the first board body. A first assembly hole 411 is provided on the first circuit board 40. The first assembly hole 411 is on the first board body 41 and provided corresponding to the first connection hole 201 in the first accommodating cavity 21a, and may be configured for assembly of the connection structure 23. The fastener 203 may pass through the first assembly hole 411 and the first connection hole 201 in sequence, to be screwed to the second connection hole 202 in the first accommodating cavity 21a. In some embodiments, a first via hole 412 is provided on the first board body 41. The first via hole 412 may be provided corresponding to the positioning column 205 in the first accommodating cavity 21a, and the positioning column 205 may pass through the first via hole 412, to position and mount the first circuit board 40 with the holder 21. In some embodiments, the first conductive portion 42 may be arranged on the first board body 41, may be annular, may be arranged in the circumferential direction of the first assembly hole 411, and may be arranged corresponding to the annular conductive contact surface 2221 on the electrical conductive member 22.

As shown in FIG. 9, in some embodiments, the second circuit board 50 may be connected to a charging interface 60. In some embodiments, the charging interface 60 may be a USB charging interface, and may be arranged in the second accommodating cavity 21b. The second circuit board 50 may include a second board body 51 and a second conductive portion 52. The second board body 51 is a square board on which a charging circuit is carried. A second assembly hole 511 is provided on the second board body 51. The second assembly hole 511 may be provided corresponding to the first connection hole 201 in the second accommodating cavity 21b. The fastener 203 may pass through the second assembly hole 511 and the first connection hole 201 in sequence and be screwed to the second connection hole 202 in the second accommodating cavity 21b. A second via hole 512 is provided on the second board body 51. The second via hole 512 may be provided corresponding to the positioning column 205 in the second accommodating cavity 21b. The positioning column 205 may pass through the second via hole 512, to position and mount the second circuit board 50 with the holder 21. In some embodiments, the second conductive portion 52 may be arranged on the second board body 51, may be annular, may be arranged in the circumferential direction of the second assembly hole 511, and may be arranged corresponding to the annular conductive contact surface 2221 on the electrical conductive member 22.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A holder assembly, comprising:
a holder;
an electrical conductive member;
a connection structure; and
a positioning structure,
wherein the positioning structure and the connection structure are arranged on the holder and the electrical conductive member, and
wherein the electrical conductive member is mounted and positioned on the holder through the positioning structure, is connected and fixed to the holder through the connection structure, and is in conductive connection to, through contact, a circuit board mounted into the holder.

2. The holder assembly of claim 1, wherein the positioning structure comprises a positioning hole and a positioning column,
wherein the positioning column is arranged on the holder, and
wherein the positioning hole is provided on the electrical conductive member, is provided corresponding to the positioning column, and is configured for the positioning column to run through.

3. The holder assembly of claim 2, wherein the electrical conductive member comprises a positioning portion, and
wherein the positioning hole is provided on the positioning portion.

4. The holder assembly of claim 1, wherein the connection structure comprises a first connection hole, a second connection hole, and a fastener,
wherein the first connection hole is provided on the electrical conductive member, and the second connection hole is provided on the holder, and
wherein the fastener runs through the first connection hole to the second connection hole to connect the electrical conductive member to the holder.

5. The holder assembly of claim 4, wherein the electrical conductive member comprises a conductive contact portion in contact with the circuit board,
wherein the first connection hole is provided on the conductive contact portion, and
wherein the fastener runs through the circuit board and the first connection hole in sequence to be connected to the second connection hole, to connect the circuit board and the conductive contact portion to the holder.

6. The holder assembly of claim 5, wherein the conductive contact portion comprises an annular conductive contact surface.

7. The holder assembly of claim 5, wherein the electrical conductive member comprises a connection portion arranged lengthwise, and
wherein there are two conductive contact portion respectively arranged at both ends of the connection portion.

8. The holder assembly of claim 7, wherein a bending portion fitting with the holder is arranged between one or two of the conductive contact portions and the connection portion.

9. The holder assembly of claim 1, wherein the holder comprises a first accommodating cavity accommodating a first circuit board and a second accommodating cavity arranged side by side with the first accommodating cavity and configured to accommodate a second circuit board, and
wherein the electrical conductive member extends from the first accommodating cavity to the second accommodating cavity and is in conductive connection to the first circuit board and the second circuit board, respectively.

10. The holder assembly of claim 1, wherein there are two electrical conductive members, and the two electrical conductive members are spaced apart on the holder.

11. The holder assembly of claim 1, wherein a limiting groove is provided on the holder, the limiting groove being configured for mounting and limiting of the electrical conductive member.

12. The holder assembly of claim 1, wherein the electrical conductive member is in a shape of a sheet.

13. The holder assembly of claim 1, wherein the electrical conductive member comprises an elastic member.

14. The holder assembly of claim 1, wherein the electrical conductive member comprises a conductive contact portion, and
wherein a conductive layer is arranged on the conductive contact portion.

15. An electronic vaporization device, comprising:
the holder assembly of claim 1; and
the circuit board mounted on the holder assembly,
wherein the circuit board is connected to the electrical conductive member of the holder assembly through the connection structure on the holder assembly.

16. The electronic vaporization device of claim 15, wherein a conductive portion in conductive contact with the electrical conductive member is arranged on the circuit board.

17. The electronic vaporization device of claim 16, wherein an assembly hole for assembly of the connection structure is provided on the circuit board, and
wherein the conductive portion is arranged on a periphery of the assembly hole.

18. The electronic vaporization device of claim 15, wherein the circuit board comprises the first circuit board and the second circuit board, and
wherein the first circuit board and the second circuit board are spaced apart and are connected through the electrical conductive member.
